(19) United States
(12) Patent Application Publication
(10) Pub. No.: US 2012/0059727 A1
(43) Pub. Date: Mar. 8, 2012

(54) SYSTEM FOR CREATING DIGITAL MEDIA IN SOCIAL VENUES AND METHODS THEREOF

(76) Inventors: ETHAN FRANK DAMERON, Raleigh, NC (US); MICHAEL FLUHARTY, Myrtle Beach, SC (US); JAMES ADAM JONES, North Myrtle Beach, SC (US); CHARLES WILLIAM MILLER, Charlotte, NC (US); ZUBAIR BIRGEOGLU, Marion, IN (US)

(21) Appl. No.: 13/193,156

(22) Filed: Jul. 28, 2011

Related U.S. Application Data
(60) Provisional application No. 61/368,350, filed on Jul. 28, 2010.

(51) Int. Cl. G06Q 30/02

(52) U.S. Cl. 705/14.72

(57) ABSTRACT

Embodiments of the present invention are generally related to a system for creating digital media in social venues and methods thereof. More specifically, embodiments of the present invention relate to a system for allowing patrons of a social venue to create collectible digital media, accessible to the patrons through a global computer network, and enable an administrator thereof to derive revenue streams therefrom. In one embodiment of the present invention, a method of for creating digital media in social venues comprises providing a digital media creation device for creating digital media, the digital media creation device having a base, a camera and an interactive screen; allowing a user to engage the digital media creation device to create the digital media, the digital media comprising multimedia content acquired from the camera and at least one advertisement; and enabling the user to retrieve a copy of the digital media.

### CROSS-REFERENCE TO RELATED APPLICATIONS

This application claims priority to U.S. Provisional Patent Application Ser. No. 61/368,350, filed Jul. 28, 2010, entitled “System for Creating Digital Media in Social Venus and Methods Thereof,” the disclosure of which is incorporated by reference in its entirety herein.

### BACKGROUND OF THE INVENTION

1. Field of the Invention

Embodiments of the present invention are generally related to a system for creating digital media in social venues and methods thereof. More specifically, embodiments of the present invention relate to a system for allowing patrons of a social venue to create collectible digital media, accessible to the patrons through a global computer network, and enable an administrator thereof to derive revenue streams therefrom.

2. Description of Related Art

Social venues, such as bars, nightclubs, concert halls, etc., are always a hotspot for attracting people looking for an enjoyable evening or night on the town. Based on a likely combination of alcohol, food and entertainment, social venues are frequently visited by people in groups—that is, two or more friends, colleagues, family members, etc. Often, the goal of such evenings is to result in a memorable event of good times and fun amongst the group.

To memorialize the evenings, people often bring cameras or phones with cameras to take pictures of their friends having a good time. However, that often requires lugging around a bulky piece of equipment, or if the person does not have pockets in her or his outfit, it requires holding onto the equipment or risk it being lost or stolen if left somewhere.

In the event photographs or video footage of the evening are obtained, it is not uncommon for such multimedia to be uploaded by the person who created the multimedia on a social networking webpage to be shared amongst friends. While only one person may have possession of the equipment used to create the multimedia, the sharing of multimedia through the social network allows all interested persons (i.e., either those in the photos, or those who are “friends” with those in the photos) to view and acquire the multimedia. As such, it is an easy forum in which memories of an evening may be shared.

Many of such social networking websites attempt to utilize targeted advertisements to reach a desired demographic of users with a third-party affiliate's ads. Using information that may be available from such users, the administrator of the social network displays certain content that it feels the user may be interested in, for example, local restaurant specials, movie trailers, etc. While many users may be interested in such content, much of the advertising cost paid gets wasted on users who have no interest in such product or service. Thus, a third-party affiliate may waste a significant amount of financial resources keeping advertisements continuously posted on the social network, rather than having one fixed in a digital medium that users will continue to view for a while without increased costs to the third-party affiliate.

In view of the above, there are needs for various embodiments of the present invention for a system for allowing patrons of a social venue to create collectible digital media, accessible to the patrons through a global computer network, and enable an administrator thereof to derive revenue streams therefrom.

### SUMMARY

Embodiments of the present invention are generally related to a system for creating digital media in social venues and methods thereof. More specifically, embodiments of the present invention relate to a system for allowing patrons of a social venue to create collectible digital media, accessible to the patrons through a global computer network, and enable an administrator thereof to derive revenue streams therefrom.

In one embodiment of the present invention, a method of for creating digital media in social venues comprises providing a digital media creation device for creating digital media, the digital media creation device having a base, a camera and an interactive screen; allowing a user to engage the digital media creation device to create the digital media, the digital media comprising multimedia content acquired from the camera and at least one advertisement; and enabling the user to retrieve a copy of the digital media.

In another embodiment of the present invention, a method of generating revenue by advertising the goods or services of a third party, comprises providing a digital media creation device for creating digital media at a social venue, the digital media creation device having a base, a camera and an interactive screen; allowing a user to engage the digital media creation device to create the digital media, the digital media comprising multimedia content acquired from the camera and at least one advertisement, the advertisement pertaining to the goods or services of the third party, the third party having compensated an administrator of the digital media creation device for the advertisement; and enabling the user to retrieve a copy of the digital media.

In yet another embodiment of the present invention, a method of creating viral advertisements comprises providing a digital media creation device for creating digital media at a social venue, the digital media creation device having a base, a camera and an interactive screen; allowing a user to engage the digital media creation device to create the digital media, the digital media comprising multimedia content acquired from the camera and at least one advertisement, the advertisement pertaining to the goods or services of the third party, the third party having compensated an administrator of the digital media creation device for the advertisement; enabling the user to enter account information for a third party networking site into the digital media creation device; and transmitting a copy of the digital media from the digital media creation device to the user's account on the third party social networking site.

### BRIEF DESCRIPTION OF THE DRAWINGS

So the manner in which the above recited features of the present invention can be understood in detail, a more particular description of embodiments of the present invention, briefly summarized above, may be had by reference to embodiments, one of which is illustrated in the appended drawings. It is to be noted, however, the appended drawings illustrate only typical embodiments of embodiments encompassed within the scope of the present invention, and, therefore, is not to be considered limiting, for the present invention may admit to other equally effective embodiments.

FIG. 1 depicts a network-based system in accordance with one exemplary embodiment of the present invention;

FIG. 2 depicts a general purpose computer system in accordance with one embodiment of the present invention;

FIG. 3 depicts an exemplary digital media creation device in accordance with one exemplary embodiment of the present invention;

FIG. 3A depicts a diagram of a commercial embodiment of the digital media creation device shown in FIG. 3;

FIG. 4 depicts a digital photograph created by a digital media creation device in accordance with one exemplary embodiment of the present invention; and

FIG. 5 depicts a flowchart of the functional relationships between components of an exemplary system, in accordance with one embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION OF THE INVENTION

Embodiments of the present invention are generally related to a system for creating digital media in social venues and methods thereof. More specifically, embodiments of the present invention relate to a system for allowing patrons of a social venue to create collectible digital media, accessible to the patrons through a global computer network, and enable an administrator thereof to derive revenue streams therefrom.

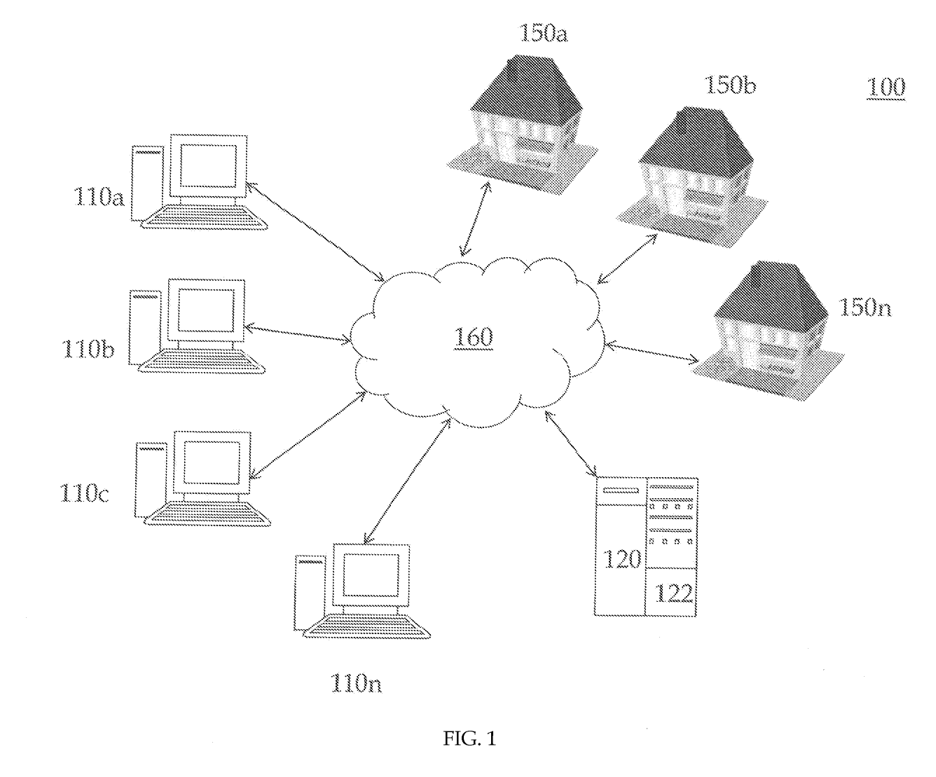

FIG. 1 depicts a network-based system in accordance with one exemplary embodiment of the present invention. The system 100 generally includes at least a first user 110a. The term “user” may also be referred to herein as an end user, patron, subject, or derivatives thereof. The system 100 may additionally include at least a second user 110b, and additional users, up to candidate 110n, where n represents any number of users practical for operation of embodiments of the present invention. The user 110 may comprise any person, business, entity or the like, suitable for embodiments of the present invention, as disclosed herein.

The system 100 further includes at least a first social venue 150a. The system 100 may additionally include at least a second social venue 150b, and additional social venues, up to social venue 150n, where n represents any number of social venues practical for operation of embodiments of the present invention. For purposes of embodiments of the present invention, a social venue 150 may comprise any venue, establishment, building or the like, capable of hosting public or private social gatherings. For example, in one embodiment, a social venue 150 may comprise a bar, a saloon, a night club, a sports arena, a school or university, a retail store or mall, banquette hall, or the like. It should be appreciated by those of ordinary skill in the art, any venue, building, residence, field, or other geographic location may be suitable for embodiments of the present invention, and may be included as an exemplary social venue 150 where suitable.

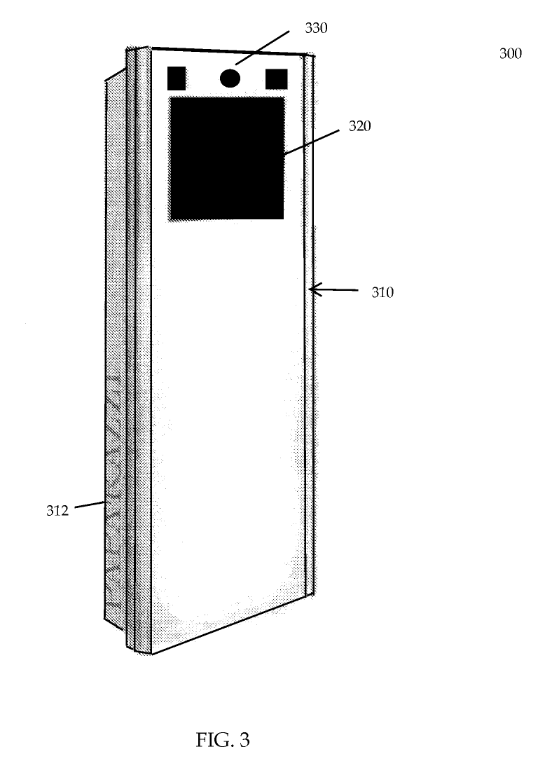

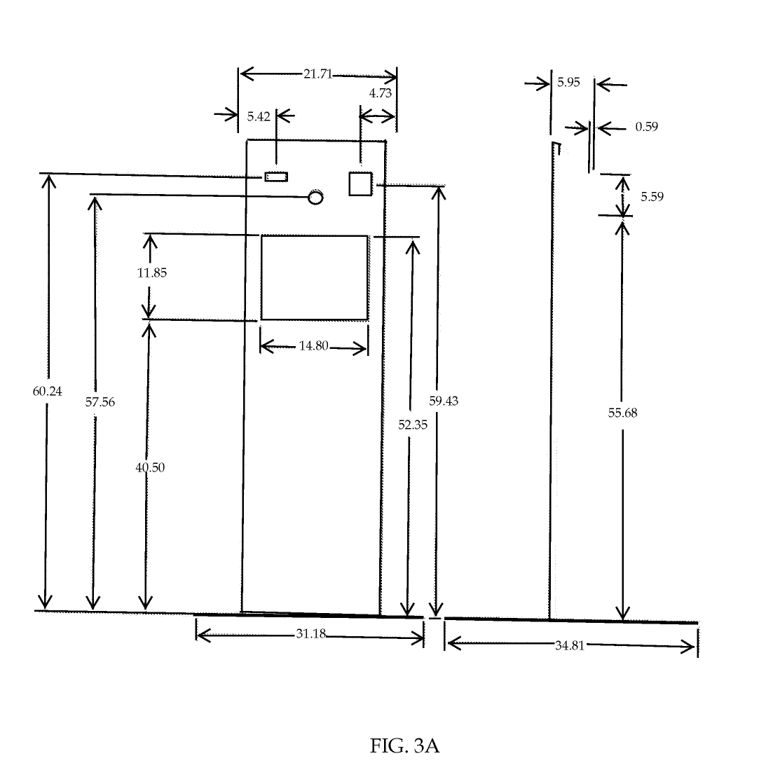

Each of the social venues 150 of the system 100 may further comprise a digital media creation device (not shown). Exemplary types of digital media creation devices may comprise still image cameras, video cameras, webcams, smart phones having image capturing devices therein, other multi-media electronic equipment or the like. In some embodiments of the present invention, the digital media creation device may comprise a combination of a device, e.g., as described above, and a computer for interacting with the users 110 or the administrator 120 through the network 160. One specific example of a digital media creation device is disclosed below, with respect to FIG. 3. As used herein, “digital media” may include all forms of multimedia data, including audio, video, moving or still, and digital or analog, suitable for embodiments of the present invention.

The system 100 further comprises an administrator or host 120, i.e., an organization, company or individual who controls, designs and is generally responsible for implementing and/or facilitating each of the methods disclosed herein. As is common in network-based business models, the administrator 120 may also comprise a web administrator, responsible for providing and maintaining a website or interactive portal through which all of the candidates 110 or users of the system 100 may interact and execute the methodology and functionality disclosed in the embodiments disclosed herein.

In one embodiment, the administrator 120 is an entity hosting an accessible server and a database 122. The server may comprise any type of computing device suitable for embodiments of the present invention. The server may be located at the administrator 120 physical site or at a remote location accessible via the network 160.

The database 122 may include a number of records in accordance with embodiments of the present invention, including data and/or other information, which may be parsed and stored. The database 122 may further comprise software, which may include and/or employ one or more database management systems (“DBMS”), such as any one of an Oracle, DB2, Microsoft Access, Microsoft SQL Server, Postgres, MySQL, 4th Dimension, FileMaker and Alpha Five DBMS, and the like. The DBMS may be operable to query the database 122, parse the information into the records, execute rules for sorting the information parsed into the records, execute rules for performing operations (e.g., mathematical, statistical, logical, etc., operations) on the information parsed into the records, and the like.

In many embodiments, the database software may be operable to apply the data from records into one or more models to form one or more output records. These output records include information that may be used to facilitate the methods disclosed herein. In addition, the database software may be operable to interface with web-server software, to allow manipulation of the database 122 via one or more web pages available to the administrator 120 via the network 160.

The network 160 may comprise any network suitable for embodiments of the present invention. For example, the network 160 may be a partial or full deployment of most any communication/computer network or link, including any of, any multiple of, any combination of or any combination of multiples of a public or private, terrestrial wireless or satellite, and wireline networks or links. The network 160 may include, for example, network elements from a Public Switch Telephone Network (PSTN), the Internet, core and proprietary public networks, wireless voice and packet-data networks, such as 1G, 2G, 2.5G, 3G and 4G telecommunication networks, wireless office telephone systems (WOTS) and/or wireless local area networks (WLANs), including, Bluetooth and/or IEEE 802.11 WLANs, wireless personal area networks (WPANs), wireless metropolitan area networks (WMANs) and the like; virtual local area networks (VLANs) and/or communication links, such as Universal Serial Bus (USB) links; parallel port links, Firewire links, RS-232 links, RS-485 links, Controller-Area Network (CAN) links, and the like.

In certain embodiments, additional third party servers may be connected to the system 100. For example, in one embodiment a third party social network server may be in communication with the administrator 120 through the network 160. In such an embodiment, the features, functions and elements of embodiments of the present invention may be shared through third party social networking sites (e.g., Facebook, MySpace, Twitter, etc.) In alternative embodiments, other types of third party servers may include email (e.g., Microsoft Exchange servers), photo hosting servers (e.g., SnapFish, PhotoBucket), or the like.

In accordance with many embodiments of the present invention, each of the parties associated with the system 100 comprise the necessary electronic devices, having platforms and databases where applicable, to execute the methods as set forth by embodiments of the present invention. Alternative system architectures are contemplated by embodiments of the present invention provided such alternative architectures are capable of executing the various methods disclosed herein.

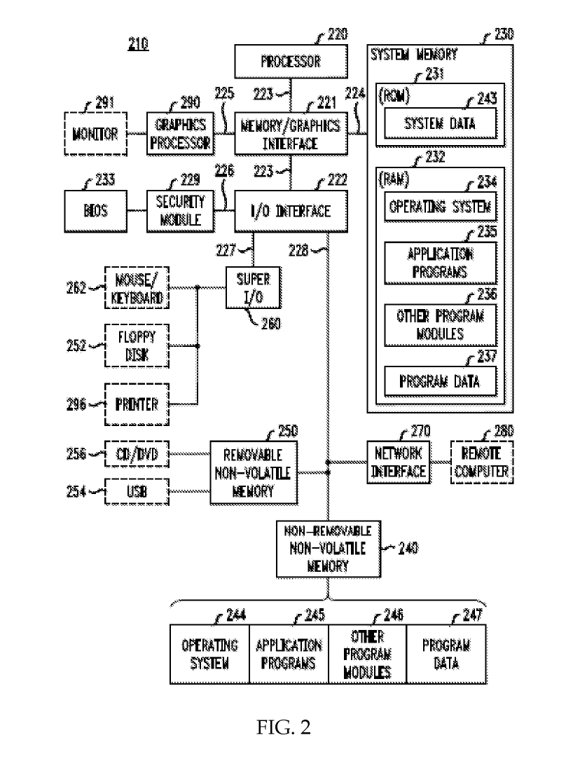

In several embodiments, the electronic device associated with each of the parties within the system comprises a general purpose computer system, for example, the general purpose computer system of FIG. 2. It should be appreciated, however, the general purpose computing system of FIG. 2 is merely an exemplary embodiment of an electronic device, and actual electronic devices may comprise any one or more components shown in FIG. 2, suitable for embodiments of the present invention.

With reference to FIG. 2, a general purpose computer system in the form of a computer 210 is shown. As understood by embodiments of the present invention, components shown in dashed outline are not part of the computer 210, but are used to illustrate the exemplary embodiment of FIG. 2. Components of computer 210 may include, but are not limited to, a processor 220, a system memory 230, a memory/graphics interface 221, also known as a Northbridge chip, and an I/O interface 222, also known as a Southbridge chip. The system memory 230 and a graphics processor 290 may be coupled to the memory/graphics interface 221. A monitor 291 or other graphic output device may be coupled to the graphics processor 290.

A series of system busses may couple various system components including a high speed system bus 223 between the processor 220, the memory/graphics interface 221 and the I/O interface 222, a front-side bus 224 between the memory/graphics interface 221 and the system memory 230, and an advanced graphics processing (AGP) bus 225 between the memory/graphics interface 221 and the graphics processor 290. The system bus 223 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hypertransport architecture, respectively.

The computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and can accessed by the computer 210.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. The system ROM 231 may contain permanent system data 243, such as identifying and manufacturing information. In some embodiments, a basic input/output system (BIOS) may also be stored in system ROM 231. RAM 232 typically contains data and/or program modules that are immediately accessible to and/or presently being operated on by processor 220. By way of example, and not limitation, FIG. 2 illustrates operating system 234, application programs 235, other program modules 236, and program data 237.

The I/O interface 222 may couple the system bus 223 with a number of other buses 226, 227 and 228 that couple a variety of internal and external devices to the computer 210. A serial peripheral interface (SPI) bus 226 may connect to a BIOS memory 233 containing the basic routines that help to transfer information between elements within computer 210, such as during start-up.

In some embodiments, a security module 229 may be incorporated to manage metering, billing, and enforcement of policies.

A super input/output chip 260 may be used to connect to a number of ‘legacy’ peripherals, such as floppy disk 252, keyboard/mouse 262, and printer 296, as examples. The super I/O chip 260 may be connected to the I/O interface 222 with a low pin count (LPC) bus, in some embodiments. The super I/O chip 260 is widely available in the commercial marketplace.

In one embodiment, bus 228 may be a Peripheral Component Interconnect (PCI) bus, or a variation thereof, may be used to connect higher speed peripherals to the I/O interface 222. A PCI bus may also be known as a Mezzanine bus. Variations of the PCI bus include the Peripheral Component Interconnect-Express (PCI-E) and the Peripheral Component Interconnect-Extended (PCI-X) busses, the former having a serial interface and the latter being a backward compatible parallel interface. In other embodiments, bus 228 may be an advanced technology attachment (ATA) bus, in the form of a serial ATA bus (SATA) or parallel ATA (PATA).

The computer 210 may also include other removable/non-removable, volatile/nonvolatile computer storage media. By way of example only, FIG. 2 illustrates a hard disk drive 240 that reads from or writes to non-removable, nonvolatile magnetic media. Removable media, such as a universal serial bus (USB) memory 252 or CD/DVD drive 256 may be connected to the PCI bus 228 directly or through an interface 250. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media, discussed above and illustrated in FIG. 2, provide storage of computer readable instructions, data structures, program modules and other data for the computer 210. In FIG. 2, for example, hard disk drive 240 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different elements within the computer 210. A user may enter commands and information into the computer 210 through input devices such as a mouse/keyboard 262 or other input device combination. Other input devices (not shown) may include a microphone, joystick, game pad, satellite dish, scanner, or the like. These and other input devices are often connected to the processor 220 through one of the I/O interface busses, such as the SPI 226, the LPC 227, or the PCI 228, but other busses may be used. In some embodiments, other devices may be coupled to parallel ports, infrared interfaces, game ports, and the like (not depicted), via the super I/O chip 260.

The computer 210 may operate in a networked environment using logical connections to one or more remote computers, such as a remote computer 280 via a network interface controller (NIC) 270. The remote computer 280 may be a personal computer, a server, a router, a network PC, a peer device or other common network node, and typically includes many or all of the elements described above relative to the computer 210. The logical connection between the NIC 270 and the remote computer 280 depicted in FIG. 2 may include a local area network (LAN), an Ethernet-based network, a wide area network (WAN), or both, but may also include other networks. Such networking environments are commonplace in offices, enterprise-wide computer networks, intranets, and the Internet.

It should be appreciated by embodiments of the present invention, execution of the methods and functions described herein with respect to the network may be executed by not only a physical computing device, for example, as shown in FIG. 2, but also on a virtual machine. Accordingly, although many physical elements are disclosed herein, the virtual equivalent of such elements may be implemented on a virtual platform without any deviation from the methods and functions disclosed herein.

As understood by embodiments of the present invention, each of the users 110, social venues 150 and/or administrator 120 of the system 100 may each utilize a computing device having any number of the components disclosed in FIG. 2. In particular, each of the users 110, social venues 150 (including a digital media creation device) and/or administrator 120 may comprise, for example, any of or any combination of a personal computer, a portable computer, a handheld computer, a cellular phone, a smart phone, a pager, a digital tablet, a laptop computer, an Internet appliance and the like, or combinations thereof. Such devices may include application software or similar medium capable of at least enabling such device to connect to network 160. One example of such software application is a web browser. A Web browser enables users to display and interact with text, images, videos, and the like typically located on a web page at a website on the Internet, World Wide Web, or any other computer network. Examples of some commercially available web browsers include, but are not limited to, Internet Explorer, Mozilla Firefox, Safari, Opera, and Netscape, each created and owned by their respective recognized manufacturers.

FIG. 3 depicts an exemplary digital media creation device in accordance with one exemplary embodiment of the present invention, and FIG. 3A depicts an engineering diagram of a proposed commercial embodiment of the digital media creation device shown in FIG. 3. In the example shown, a digital media creation device 300 generally comprises a base 310, an interactive screen 320, and a camera 330. The base 310 may comprise any suitable housing structure for embodiments of the present invention. For example, in one embodiment, the base 310 comprises a substantially rectangular tower-like housing, fully encasing a number of electrical and computer components working in conjunction with the interactive screen 320 and the camera 330.

In some embodiments, the base 310 may comprise an outer surface thereof 312 that may be utilized as advertising or promotional space. In certain embodiments of the present invention, where advertising revenue is sought, the outer surface 312 may comprise any brand, logo, slogan, or other source identifying mark of a third party. Although shown in FIG. 3 as a side panel of the base 310, the outer surface 312 that may be utilized as advertising space may comprise the entire outer surface of the base 310, or any portion thereof, in accordance with embodiments of the present invention.

The interactive screen 320 may comprise any type of visual device suitable for embodiments of the present invention. In one embodiment, the interactive screen 320 may comprise a touch screen apparatus, in communication with a computing device, to engage users of the digital media creation device 300 and receive instructions therefrom. In some embodiments, the interactive screen 320 may merely comprise a visual monitor, such as a traditional LED screen, such as those found in many television sets. In such embodiments, the level of interactivity through the screen may be in the form of presentation of visual information. Optionally, the interactive screen 320 may merely comprise a tactile portion, such as a plurality of mechanical buttons, with which a user of the digital media creation device 300 may provide information to the device 300, in accordance with embodiments of the present invention. Although the term “screen” is utilized, embodiments of the present invention should not be limited to include a visual monitor.

The camera 330 may comprise any type of camera suitable for embodiments of the present invention. In one embodiment, the camera 330 comprises any one of a still image camera, a video camera, a web camera, or the like. The camera 330 may be utilized to obtain data, when requested, and to store such data in a memory within the camera itself or within a computing device (not shown) within the digital media creation device 300. The camera 330 may utilize any level of resolution, image size, zoom, or other typical camera-related characteristics, provided such characteristics are suitable to perform requisite functions as disclosed herein. In accordance with certain embodiments of the present invention, the camera 330 may also be provided with a flash or similar light assistance mechanism within the digital media creation device 300.

Although not shown in FIG. 3, digital media creation device 300 may comprise a computing device, either internal to the digital media creation device 300 or merely in communication therewith. The computing device may comprise any of the devices described hereinabove, and may comprise any number of the components disclosed in the general purpose computer shown in FIG. 2. Some embodiments of the present invention comprise a system wherein the digital media creation device 300 utilizes a computing device to remain in contact with the administrator, through the network, and may do so via any known means suitable for embodiments of the present invention.

In certain embodiments, advanced features such as a proximity detection system, face recognition software, etc., may be provided within the digital media creation device 300. A proximity detection system may allow the digital media creation device 300 to know when a user or users are within the appropriate location for the camera to acquire data. Similarly, the face recognition software may allow the digital media creation device 300 to instruct the camera to focus on the user or users' faces when acquiring the data.

In accordance with embodiments of the present invention, a digital media creation device may be positioned within a social venue, for example, a neighborhood bar. The digital media creation device may be placed in a strategic location within the social venue, and may be positioned adjacent any type of backdrop, screen, prop, or the like, to give a particular desired appearance or false impression of the actual location of the social venue. For example, in one embodiment, by utilizing a backdrop, a red carpet and a velvet rope, the setting adjacent the digital media creation device may give a feeling of being in a Hollywood movie premiere, or similar celebrity-filled venue.

Generally, the digital media creation device is positioned in front of any type of desired background setting, such that the viewable angle of the camera is limited to the desired background. In certain embodiments, the spacing and width of the background setting will be dependent upon the nature and type of camera utilized in the digital media creation device. When utilized, the digital media creation device is capable of capturing and storing an image of a person, or persons, in front of a desired background, utilizing any number of desired props, and storing such information to be utilized as disclosed herein.

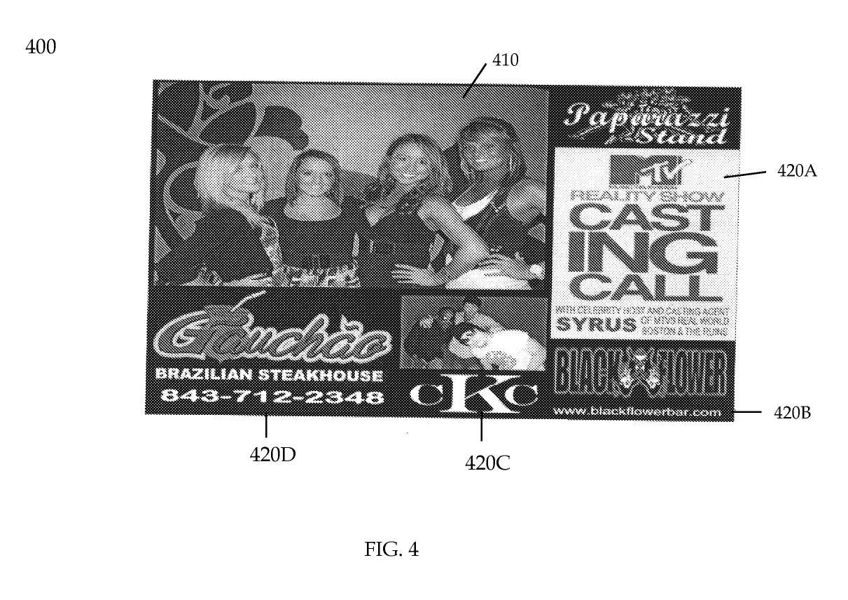

FIG. 4 depicts a digital photograph created by a digital media creation device in accordance with one exemplary embodiment of the present invention. As shown in the Figure, a digital photograph 400 may comprise numerous sections or divisions thereon. Generally, a digital photograph 400 comprises digital media 410 in at least one of the sections, the digital media 410 showing, for example, the image created by the digital media creation device. In addition thereto, the digital photograph 400 generally comprises at least one advertisement 420A, or plurality of advertisements 420A-D, positioned on the digital photograph 400. As used herein, an advertisement may comprise any type of third party message, promotional event, business listing, or the like. For purposes of embodiments of the present invention, any type of multimedia content may be positioned within the advertisements 420 on the digital photograph 400.

Embodiments of the present invention enable an administrator to derive revenue streams from the creation of the digital media. As shown in FIG. 4, the administrator may derive revenue streams from the digital media by placing advertisements 420 around the digital photograph 400. Such advertisements 420 may comprise any size, shape, or positioning within the digital photograph 400, in accordance with certain embodiments of the present invention. The administrator may charge any type of fee or subscription for the placements of the advertisements.

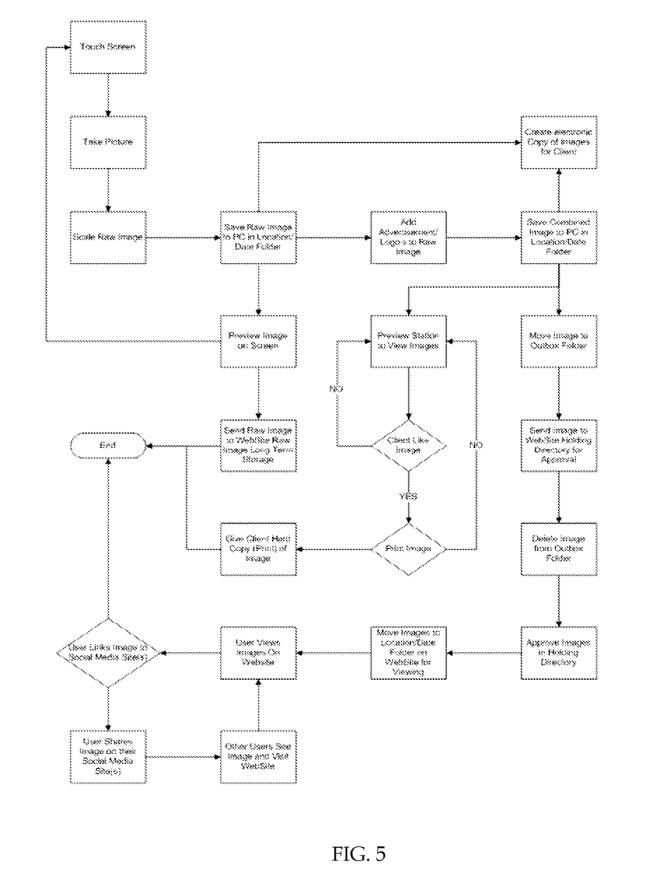

FIG. 5 depicts a flowchart of the functional relationships between components of an exemplary system, in accordance with one embodiment of the present invention. Generally, before such functionality can take place, a system, such as the system 100 of FIG. 1, must be provided. In addition, the system 100 must further comprise a digital media creation device at each of the social venues therein, for example, such as the digital media creation device 300 of FIG. 3.

Generally, a method of utilizing a system begins with utilizing a touch screen of the digital media creation device to provide instructions that a person, or group of people, wish to be photographed, videographed, audiotaped, etc. (for sake of convenience, reference is made herein with regard to a photograph, but embodiments of the present invention should not be limited thereto). In many embodiments, the touch screen may provide a few different choices for what type of digital media may be taken, where such pictures should be stored or electronically sent, or the like. In addition, the touch screen may also provide a set of instructions for how to utilize the device, and step users through a self-photographing process utilizing the digital media creation device. Optionally, in certain embodiments, an agent of the administrator or the social venue may be positioned near the digital media creation device to assist users in the process.

In one embodiment, whereby the touch screen provides instructions on how to step through the self-photographing process, a user may indicate that he or she is ready to have a photograph taken, and will be provided a short time period (e.g., 10 seconds) in which to get in position for the photograph. In such embodiment, the touch screen may “countdown” or otherwise indicate when it is about to take the photograph, so the user may be prepared.

Once the photograph is taken, the raw image (i.e., the image data file) can be saved by the digital media creation device. In accordance with various embodiments of the present invention, the image may be saved in a memory within a computing device within the digital media creation device. The image may also be previewed on the touch screen, whereby the user may have options to confirm the image, elect to retake the image, edit the image with photo-editing software, or the like.

Once the image is accepted, many embodiments of the present invention provide that advertisements shall be placed around the digital image, for example, as shown in FIG. 4. The modified image, with the advertisements, may subsequently be saved in a memory within a computing device within the digital media creation device.

Once the image and/or modified image are saved, a number of plausible scenarios for enabling the user to retrieve a copy of the digital media are presented. In one embodiment, the images may be sent via email or other transfer protocol to a website hosting directory, whereby users may utilize a personal computing device (e.g., a computer, cell phone, etc.) to review and download the images. In another embodiment, the users may be presented with an option to review the images and have them shared with one or more social networking sites. In yet another embodiment, the images may be emailed directly to the user for dissemination or distribution. In yet a further embodiment, images may be printed and purchased at a designated location, for example, within a separate kiosk within the social venue. In accordance with embodiments of the present invention, once the images are created and stored, any plausible distribution of such images is contemplated by embodiments of the present invention.

As shown in FIG. 5, the flowchart of the functional relationships between components of the exemplary system provides more detail regarding the options posed in the example. It should be appreciated by those of ordinary skill in the art, the example shown is merely one means of accomplishing the desired results of embodiments of the present invention—that is, to allow patrons of a social venue to create collectible digital media, accessible to the patrons through a global computer network, and enable an administrator thereof to derive revenue streams therefrom.

With regard to revenue streams available to the administrator, embodiments of the present invention contemplate a variety of avenues through which revenue may be derived. For example, in one embodiment, revenue may be derived from any one of: selling advertising space on the pictures posted on the website, selling advertising space on the digital media creation device, selling pictures on the website without the watermark or ads (e.g., digital download), selling hard copy pictures through the website without the watermark (e.g., printed hardcopy), selling advertising on the background banners to be used in the images, or the like.

In an alternative embodiment, the administrator may utilize the digital media creation device as a means to acquire information about the users thereof, and sell such information for marketing or advertising purposes. For example, in one embodiment, the digital media creation device may require the user to provide an email address to utilize the device. Once the email is obtained, the administrator may store such information and sell it later to either the venue, a vendor of the venue (e.g., a liquor company that sponsored the venue that evening), a third party (e.g., a band that played at the venue that evening), or the like. Beyond emails, certain embodiments of the present invention may collect additional demographic or personal information for use in any type of targeted advertising system or the like.

In further embodiments, the administrator may elect to operate a franchisor/franchisee business model, utilizing the systems and method disclosed herein. For example, the administrator may elect to allow a franchisee to install, operate, and service a number of digital media creation devices at any number of social venues within a particular area. In such embodiments, the administrator may retain control over the network, the server, the database and/or other components common to a plurality of franchisees. As understood by embodiments of the present invention, by utilizing a franchise model, the administrator may license and/or contract any portion of the system and/or methods to any third party to operate in accordance with embodiments disclosed herein.

Alternative embodiments of the present invention may comprise a number of additional features to further enhance the desirability of utilization of the system and methods described herein. In one embodiment, a system may comprise a secondary kiosk that users can interact with and purchase and print or download their photos. In another embodiment, users may be able to send the pictures directly to their cell phone from the kiosk using a MMS feature or email. In yet a further embodiment, users may be able to utilize a Chroma-Key backdrop (i.e., green screen) to allow users to choose their own background or allow digital change of a background banner.

In another embodiment of the present invention, users may ‘broadcast’ their presence directly from a digital media creation device—similar to known social media distribution sites (e.g., FourSquare.com). For example, the digital media creation device may be able to upload a picture directly to a social networking site (e.g., Facebook.com, MySpace.com, etc.). In such embodiments, a user may be required to subscribe or “friend” any of the venue, the administrator or the like, before being able to access the digital media. By doing so, the venue, administrator, etc. may be presented with additional direct access to the persons interested in the digital media, thus increasing their exposure for their own advertising and promotions through the social network.

Where a third party social networking site is included, embodiments of the present invention may be utilized to create viral advertisements. Once digital media is created, as described hereinabove, a user may post the digital media to their social networking pages. In many embodiments, as social network “friends” of that user view, share and “tag” the digital media, it subsequently shared on their respective social network pages. As such, the advertisement placed on the digital media is viewed by any number of people based on the degrees of separation and visibility between the initial user and each of those users friends, and so on.

While the foregoing is directed to embodiments of the present invention, other and further embodiments of the invention may be devised without departing from the basic scope thereof. Specifically, embodiments of the present invention are further scalable to allow for additional clients and servers, as particular applications may require.

What is claimed is:

1. A method of for creating digital media in social venues comprising:
providing a digital media creation device for creating digital media, the digital media creation device having a base, a camera and an interactive screen;
allowing a user to engage the digital media creation device to create the digital media, the digital media comprising multimedia content acquired from the camera and at least one advertisement; and
enabling the user to retrieve a copy of the digital media.

2. The method of claim 1, wherein the camera comprises one of a still image camera, a video camera, a web camera, or combinations thereof.

3. The method of claim 1, wherein the interactive screen comprises one of a touch screen apparatus, a visual monitor, a tactile portion or combinations thereof.

4. The method of claim 1, wherein allowing a user to engage the digital media creation device to create digital media comprises:
obtaining operating instructions from the user; and
recording multimedia content acquired from the camera on a memory within the digital media creation device.

5. The method of claim 4, wherein allowing a user to engage the digital media creation device to create digital media further comprises:
displaying the multimedia content on the interactive screen for the user to preview for purposes of acceptance, rejection, edit, or combinations thereof, of the multimedia content.

6. The method of claim 1, wherein enabling the user to retrieve a copy of the digital media comprises allowing the user to enter user information into the digital media creation device.

7. The method of claim 6, wherein the user information comprises one of an email address, account information for a website hosting directory, account information for a third party social networking site, a telephone number capable of receiving MMS or SMS information, or combinations thereof.

8. The method of claim 7, further comprising transmitting the copy of the digital media from the digital media creation device to one of the email address, the website hosting directory, the third party social networking site, or the telephone number.

9. The method of claim 1, wherein enabling the user to retrieve a copy of the digital media comprises printing a hard copy of the digital media.

10. A method of generating revenue by advertising the goods or services of a third party, comprising:
providing a digital media creation device for creating digital media at a social venue, the digital media creation device having a base, a camera and an interactive screen;
allowing a user to engage the digital media creation device to create the digital media, the digital media comprising multimedia content acquired from the camera and at least one advertisement, the advertisement pertaining to the goods or services of the third party, the third party having compensated an administrator of the digital media creation device for the advertisement; and
enabling the user to retrieve a copy of the digital media.

11. The method of claim 10, wherein the camera comprises one of a still image camera, a video camera, a web camera, or combinations thereof.

12. The method of claim 10, wherein the interactive screen comprises one of a touch screen apparatus, a visual monitor, a tactile portion or combinations thereof.

13. The method of claim 10, wherein allowing a user to engage the digital media creation device to create digital media comprises:
obtaining operating instructions from the user; and
recording multimedia content acquired from the camera on a memory within the digital media creation device.

14. The method of claim 13, wherein allowing a user to engage the digital media creation device to create digital media further comprises:
displaying the multimedia content on the interactive screen for the user to preview for purposes of acceptance, rejection, edit, or combinations thereof, of the multimedia content.

15. The method of claim 10, wherein enabling the user to retrieve a copy of the digital media comprises allowing the user to enter user information into the digital media creation device.

16. The method of claim 15, wherein the user information comprises one of an email address, account information for a website hosting directory, account information for a third party social networking site, a telephone number capable of receiving MMS or SMS information, or combinations thereof.

17. The method of claim 16, further comprising transmitting the copy of the digital media from the digital media creation device to one of the email address, the website hosting directory, the third party social networking site, or the telephone number.

18. The method of claim 10, wherein enabling the user to retrieve a copy of the digital media comprises printing a hard copy of the digital media.

19. A method of creating viral advertisements comprising:
providing a digital media creation device for creating digital media at a social venue, the digital media creation device having a base, a camera and an interactive screen;
allowing a user to engage the digital media creation device to create the digital media, the digital media comprising multimedia content acquired from the camera and at least one advertisement, the advertisement pertaining to the goods or services of the third party, the third party having compensated an administrator of the digital media creation device for the advertisement;
enabling the user to enter account information for a third party networking site into the digital media creation device; and
transmitting a copy of the digital media from the digital media creation device to the user's account on the third party social networking site.

20. The method of claim 19, further comprising:
enabling the user to share the digital media amongst a plurality of contacts on the third party social networking site.
